(19) United States
(12) Patent Application Publication
(10) Pub. No.: US 2026/0082368 A1
(43) Pub. Date: Mar. 19, 2026

(54) INTELLIGENTLY CONFIGURING THE LENGTH OF RADIO LINK CONTROL SEQUENCE NUMBERS

(71) Applicant: AT&T Intellectual Property I, L.P., Atlanta, GA (US)

(72) Inventors: Jianchun Zhou, Bellevue, WA (US); Yakun Gao, Suwanee, GA (US)

(21) Appl. No.: 18/890,733

(22) Filed: Sep. 19, 2024

(51) Int. Cl. H04W 72/04; H04L 5/00

(52) U.S. Cl. CPC H04W 72/04; H04L 5/0098

(57) ABSTRACT

A method performed by a processing system including at least one processor includes identifying a service that is to transmit data to a user endpoint device over a radio access network, determining a length for a radio link control sequence number of a radio link control protocol data unit associated with the service, where the length is determined based on at least one of: a number of component carriers of a carrier aggregation scheme assigned to the user endpoint device, a radio condition of the user endpoint device, or a configuration of the radio access network, and configuring the radio link control protocol data unit with the length for the radio link control sequence number that is determined.

The present disclosure relates generally to wireless communications and relates more particularly to devices, non-transitory computer-readable media, and methods for intelligently configuring the length of radio link control sequence numbers in an intelligent manner.

### BACKGROUND

The radio link control (RLC) layer in the Fifth Generation (5G) new radio (NR) stack is responsible for transferring protocol data units (PDUs) that involve segmentation, reordering, reassembly, and error correction. The RLC layer has a PDU data buffer to store data packets from the media access control (MAC) layer, where the data packets correspond to each of the component carriers in a carrier aggregation scheme. The data packets from all of the MAC layer entities must arrive at the RLC layer within a predefined period of time for the RLC layer to reassemble the data packets into an RLC service data unit (SDU), which is then forwarded to the higher packet data convergence protocol (PDCP) layer.

### SUMMARY

In one example, the present disclosure describes a device, computer-readable medium, and method for configuring the length of radio link control sequence numbers in an intelligent manner. For instance, in one example, a method performed by a processing system including at least one processor includes identifying a service that is to transmit data to a user endpoint device over a radio access network, determining a length for a radio link control sequence number of a radio link control protocol data unit associated with the service, where the length is determined based on at least one of: a number of component carriers of a carrier aggregation scheme assigned to the user endpoint device, a radio condition of the user endpoint device, or a configuration of the radio access network, and configuring the radio link control protocol data unit with the length for the radio link control sequence number that is determined.

In another example, a non-transitory computer-readable medium stores instructions which, when executed by a processor, cause the processor to perform operations. The operations include identifying a service that is to transmit data to a user endpoint device over a radio access network, determining a length for a radio link control sequence number of a radio link control protocol data unit associated with the service, where the length is determined based on at least one of: a number of component carriers of a carrier aggregation scheme assigned to the user endpoint device, a radio condition of the user endpoint device, or a configuration of the radio access network, and configuring the radio link control protocol data unit with the length for the radio link control sequence number that is determined.

In another example, a device includes a processor and a computer-readable medium storing instructions which, when executed by the processor, cause the processor to perform operations. The operations include identifying a service that is to transmit data to a user endpoint device over a radio access network, determining a length for a radio link control sequence number of a radio link control protocol data unit associated with the service, where the length is determined based on at least one of: a number of component carriers of a carrier aggregation scheme assigned to the user endpoint device, a radio condition of the user endpoint device, or a configuration of the radio access network, and configuring the radio link control protocol data unit with the length for the radio link control sequence number that is determined.

### BRIEF DESCRIPTION OF THE DRAWINGS

The teachings of the present disclosure can be readily understood by considering the following detailed description in conjunction with the accompanying drawings, in which:

FIG. 1 illustrates an example network, or system, in which examples of the present disclosure may operate;

FIG. 2 illustrates a flowchart of an example method for configuring the length of radio link control sequence numbers in an intelligent manner, in accordance with the present disclosure;

FIG. 3A is a table illustrating one example of a scheme for determining a length for the sequence number in accordance with FIG. 2;

FIG. 3B illustrates a table illustrating example services that may be associated with different combinations of fifth generation quality of service identifiers, resource types, priority levels, delay budgets, error rates, data burst volumes, and averaging windows;

FIG. 4 illustrates two charts comparing the resultant throughput when using a protocol data unit packet sequence number of twelve bits in length versus using a protocol data unit packet sequence number of eighteen bits in length for a single component carrier;

FIG. 5A and FIG. 5B illustrate two additional charts comparing the resultant throughput when using a protocol data unit packet sequence number of twelve bits in length versus using a protocol data unit packet sequence number of eighteen bits in length for carrier aggregation using two component carriers; and

FIG. 6 depicts a high-level block diagram of a computing device specifically programmed to perform the functions described herein.

To facilitate understanding, identical reference numerals have been used, where possible, to designate identical elements that are common to the figures.

### DETAILED DESCRIPTION

In one example, the present disclosure configures the length of radio link control sequence numbers in an intelligent manner. As discussed above, the radio link control (RLC) layer in the Fifth Generation (5G) new radio (NR) stack is responsible for transferring protocol data units (PDUs) that involve segmentation, reordering, reassembly, and error correction. The RLC layer has a PDU data buffer to store data packets from the media access control (MAC) layer, where the data packets correspond to each of the component carriers in a carrier aggregation scheme. The data packets from all of the MAC layer entities must arrive at the RLC layer within a predefined period of time for the RLC layer to reassemble the data packets into an RLC SDU, which is then forwarded to the higher packet data convergence protocol (PDCP) layer.

If even one of the data packets from the MAC layer is delayed, re-assembly of the PDUs at the RLC layer may be compromised. Thus, the PDU data buffer must be large enough to store all of the data packets before expiration of the predefined period of time. The size of the PDU data buffer is typically determined by the length of the PDU's sequence number (SN), which is an important parameter for 5G and long term evolution (LTE) radio network performance. SN typically ranges from four to eighteen bits and is configurable based on quality of service (QoS) class identifier (QCI). In other words, the same length SN is used for transmissions having the same QCI.

Transmissions based on a single component carrier (1CC) or small packet services (e.g., voice services) typically do not require long SNs. However, longer SN lengths may ensure better throughput for carrier aggregation transmissions based on two (2CC), three (3CC), or more component carriers. Despite this, the same length SN is typically used for all transmissions, regardless of the number of carrier components. This has been shown to result in a degradation in throughput of ten to fifty percent, depending on the number of carrier components.

Examples of the present disclosure dynamically adjust the length of a radio link control layer sequence number for a transmission based on at least one of the following factors: a number of component carriers associated with the transmission, radio conditions of a user endpoint device associated with the transmission, or a configuration of the radio access network which handles the transmission. In some examples, the QCI of the transmission may also factor into the length of the SN, but it is not the only factor on which the length of the SN is determined.

By intelligently adjusting the length of the SN based on this combination of factors, carrier aggregation throughput can be increased by approximately ten to fifty percent, based on the number of component carriers and other factors. Moreover, by reducing the number of retransmissions in the RLC layer due to insufficient PDU data buffer size (for sequence numbers that are too short), transmission latency in the network can be significantly reduced, which will improve the performance of delay-sensitive services such as 5G ultra-reliable low latency communications (URLLC) and other services. Moreover, spectrum efficiency can be improved relative to techniques that use the same length SN for all transmissions of the same QCI.

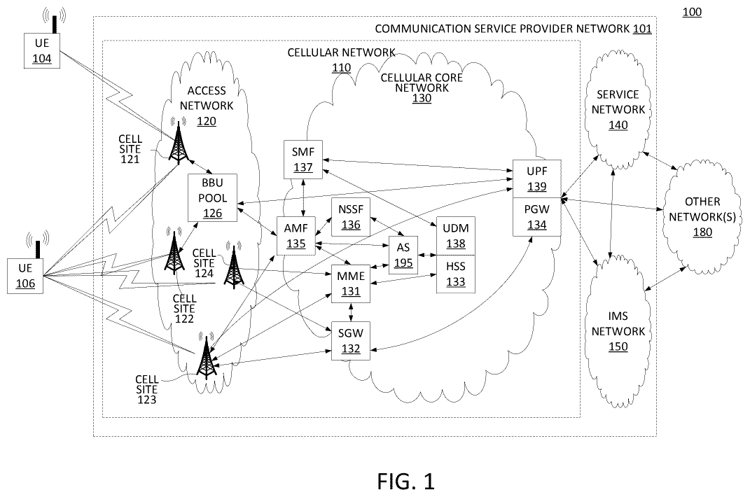

In further examples, buffer-based multiple user multiple input, multiple output (MU-MIMO) communications may be used when the length of the sequence number is relatively short (e.g., below a threshold length and/or easily exceeds an RLC buffer threshold) to conserve radio spectrum resources by reusing the entire radio spectrum when user endpoint devices are spatially separated. In particular, when the sequence number length is below a threshold length (e.g., exceeds an RLC buffer threshold), the buffer will become full relatively quickly, which will trigger MU-MIMO communications not only for services like enhanced mobile broadband (eMBB), but also ultra-high reliability and low latency (URLCC), streaming video services, and other relatively low bitrate services. These and other aspects of the present disclosure are discussed in greater detail in connection with FIGS. 1-6, below.

FIG. 1 illustrates an example network, or system, 100 in which examples of the present disclosure may operate. In one example, the system 100 includes a communication service provider network 101. The communication service provider network 101 may comprise a cellular network 110 (e.g., a 5G network, a 4G/Long Term Evolution (LTE)/5G hybrid network, or the like), a service network 140, and an IP Multimedia Subsystem (IMS) network 150. The system 100 may further include other networks 180 connected to the communication service provider network 101.

In one example, the cellular network 110 comprises an access network 120 and a cellular core network 130. In one example, the access network 120 comprises a cloud RAN. A cloud RAN, however, is just one example of a RAN with which examples of the present disclosure may work. Examples of the present disclosure work with all types of RANs, including distributed RANS (D-RANs), centralized RANs (C-RANs), virtualized RANS (V-RANs), and open RANS (O-RANs).

For instance, a cloud RAN is part of the 3GPP 5G specifications for mobile networks. As part of the migration of cellular networks towards 5G, a cloud RAN may be coupled to an Evolved Packet Core (EPC) network until new cellular core networks are deployed in accordance with 5G specifications. In one example, access network 120 may include cell sites 121 and 122 and a baseband unit (BBU) pool 126. In a cloud RAN, radio frequency (RF) components, referred to as remote radio heads (RRHs) or radio units (RUs), may be deployed remotely from baseband units, e.g., atop cell site masts, buildings, and so forth. In one example, the BBU pool 126 may be located at distances as far as 20-80 kilometers or more away from the antennas/remote radio heads of cell sites 121 and 122 that are serviced by the BBU pool 126. It should also be noted in accordance with efforts to migrate to 5G networks, cell sites may be deployed with new antenna and radio infrastructures such as MIMO antennas, and millimeter wave antennas.

Although cloud RAN infrastructures may include distributed RRHs and centralized baseband units, a heterogeneous network may include cell sites where RRH and BBU components remain co-located at the cell site. For instance, cell site 123 may include RRH and BBU components. Thus, cell site 123 may comprise a self-contained “base station.” With regard to cell sites 121 and 122, the “base stations” may comprise RRHs at cell sites 121 and 122 coupled with respective baseband units of BBU pool 126. In one example, baseband unit functionality may be split into a centralized unit (CU) and a distributed unit (DU). In addition, the CU and the DU may be physically separate from one another. For instance, a DU may be situated with an RU/RRH at a cell site, while a CU may be in a centralized location hosting multiple CUs. Alternatively, or in addition, a single CU may serve multiple DUs and/or RUs/RRHs. In accordance with the present disclosure a “base station” may therefore comprise at least a BBU (e.g., in one example, a CU and/or a DU), and may further include at least one RRH/RU.

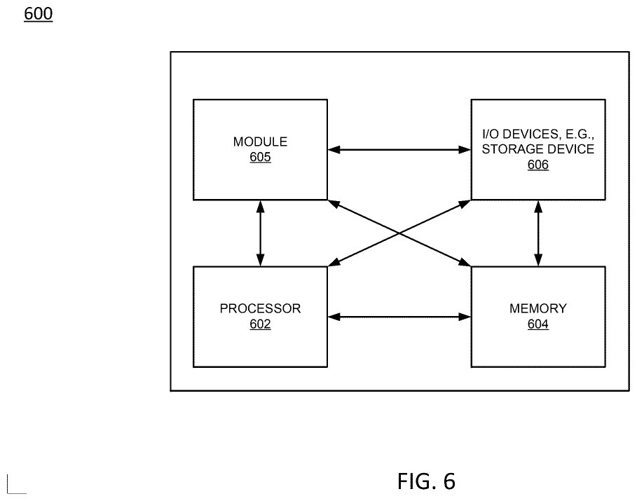

In accordance with the present disclosure, any one or more of cell sites 121-123 may be deployed with antenna and radio infrastructures, including MIMO and millimeter wave antennas. Furthermore, in accordance with the present disclosure, a base station (e.g., cell sites 121-123 and/or baseband units within BBU pool 126) may comprise all or a portion of a computing system, such as computing system 600 as depicted in FIG. 6, and may be configured to perform steps, functions, and/or operations in connection with examples of the present disclosure for configuring the length of radio link control sequence numbers in an intelligent manner.

In one example, access network 120 may include both 4G/LTE and 5G/NR radio access network infrastructure. For example, access network 120 may include cell site 124, which may comprise 4G/LTE base station equipment, e.g., an eNodeB. In addition, access network 120 may include cell sites comprising both 4G and 5G base station equipment, e.g., respective antennas, feed networks, baseband equipment, and so forth. For instance, cell site 123 may include both 4G and 5G base station equipment and corresponding connections to 4G and 5G components in cellular core network 130. Although access network 120 is illustrated as including both 4G and 5G components, in another example, 4G and 5G components may be considered to be contained within different access networks. Nevertheless, such different access networks may have a same wireless coverage area, or fully or partially overlapping coverage areas.

In one example, the cellular core network 130 provides various functions that support wireless services in the LTE environment. In one example, cellular core network 130 is an Internet Protocol (IP) packet core network that supports both real-time and non-real-time service delivery across a LTE network, e.g., as specified by the 3GPP standards. In one example, cell sites 121 and 122 in the access network 120 are in communication with the cellular core network 130 via baseband units in BBU pool 126.

In cellular core network 130, network nodes such as Mobility Management Entity (MME) 131 and Serving Gateway (SGW) 132 support various functions as part of the cellular network 110. For example, MME 131 is the control node for LTE access network components, e.g., eNodeB aspects of cell sites 121-123. In one embodiment, MME 131 is responsible for UE (User Equipment) tracking and paging (e.g., such as retransmissions), bearer activation and deactivation process, selection of the SGW, and authentication of a user. In one embodiment, SGW 132 routes and forwards user data packets, while also acting as the mobility anchor for the user plane during inter-cell handovers and as an anchor for mobility between 5G, LTE and other wireless technologies, such as 2G and 3G wireless networks.

In addition, cellular core network 130 may comprise a Home Subscriber Server (HSS) 133 that contains subscription-related information (e.g., subscriber profiles), performs authentication and authorization of a wireless service user, and provides information about the subscriber's location. The cellular core network 130 may also comprise a packet data network (PDN) gateway (PGW) 134 which serves as a gateway that provides access between the cellular core network 130 and various packet data networks (PDNs), e.g., service network 140, IMS network 150, other network(s) 180, and the like.

The foregoing describes long term evolution (LTE) cellular core network components (e.g., EPC components). In accordance with the present disclosure, cellular core network 130 may further include other types of wireless network components e.g., 5G network components, 3G network components, etc. Thus, cellular core network 130 may comprise an integrated network, e.g., including any two or more of 2G-5G infrastructures and technologies (or any future infrastructures and technologies to be deployed, e.g., 6G), and the like. For example, as illustrated in FIG. 1, cellular core network 130 further comprises 5G components, including: an access and mobility management function (AMF) 135, a network slice selection function (NSSF) 136, a session management function (SMF) 137, a unified data management function (UDM) 138, and a user plane function (UPF) 139.

In one example, AMF 135 may perform registration management, connection management, endpoint device reachability management, mobility management, access authentication and authorization, security anchoring, security context management, coordination with non-5G components, e.g., MME 131, and so forth. NSSF 136 may select a network slice or network slices to serve an endpoint device, or may indicate one or more network slices that are permitted to be selected to serve an endpoint device. For instance, in one example, AMF 135 may query NSSF 136 for one or more network slices in response to a request from an endpoint device to establish a session to communicate with a PDN. The NSSF 136 may provide the selection to AMF 135, or may provide one or more permitted network slices to AMF 135, where AMF 135 may select the network slice from among the choices. A network slice may comprise a set of cellular network components, such as AMF(s), SMF(s), UPF(s), and so forth that may be arranged into different network slices which may logically be considered to be separate cellular networks. In one example, different network slices may be preferentially utilized for different types of services. For instance, a first network slice may be utilized for sensor data communications, Internet of Things (IoT), and machine-type communication (MTC), a second network slice may be used for streaming video services, a third network slice may be utilized for voice calling, a fourth network slice may be used for gaming services, and so forth.

In one example, SMF 137 may perform endpoint device IP address management, UPF selection, UPF configuration for endpoint device traffic routing to an external packet data network (PDN), charging data collection, quality of service (QoS) enforcement, and so forth. UDM 138 may perform user identification, credential processing, access authorization, registration management, mobility management, subscription management, and so forth. As illustrated in FIG. 1, UDM 138 may be tightly coupled to HSS 133. For instance, UDM 138 and HSS 133 may be co-located on a single host device, or may share a same processing system comprising one or more host devices. In one example, UDM 138 and HSS 133 may comprise interfaces for accessing the same or substantially similar information stored in a database on a same shared device or one or more different devices, such as subscription information, endpoint device capability information, endpoint device location information, and so forth. For instance, in one example, UDM 138 and HSS 133 may both access subscription information or the like that is stored in a unified data repository (UDR) (not shown).

UPF 139 may provide an interconnection point to one or more external packet data networks (PDN(s)) and perform packet routing and forwarding, QoS enforcement, traffic shaping, packet inspection, and so forth. In one example, UPF 139 may also comprise a mobility anchor point for 4G-to-5G and 5G-to-4G session transfers. In this regard, it should be noted that UPF 139 and PGW 134 may provide the same or substantially similar functions, and in one example, may comprise the same device, or may share a same processing system comprising one or more host devices.

It should be noted that other examples may comprise a cellular network with a “non-stand alone” (NSA) mode architecture where 5G radio access network components, such as a “new radio” (NR), “gNodeB” (or “gNB”), and so forth are supported by a 4G/LTE core network (e.g., an EPC network), or a 5G “standalone” (SA) mode point-to-point or service-based architecture where components and functions of an EPC network are replaced by a 5G core network (e.g., a “5GC”). For instance, in non-standalone (NSA) mode architecture, LTE radio equipment may continue to be used for cell signaling and management communications, while user data may rely upon a 5G new radio (NR), including millimeter wave communications, for example. However, examples of the present disclosure may also relate to a hybrid, or integrated 4G/LTE-5G cellular core network such as cellular core network 130 illustrated in FIG. 1. In this regard, FIG. 1 illustrates a connection between AMF 135 and MME 131, e.g., an “N26” interface which may convey signaling between AMF 135 and MME 131 relating to endpoint device tracking as endpoint devices are served via 4G or 5G components, respectively, signaling relating to handovers between 4G and 5G components, and so forth.

In one example, service network 140 may comprise one or more devices for providing services to subscribers, customers, and or users. For example, communication service provider network 101 may provide a cloud storage service, web server hosting, and other services. As such, service network 140 may represent aspects of communication service provider network 101 where infrastructure for supporting such services may be deployed. In one example, other networks 180 may represent one or more enterprise networks, a circuit switched network (e.g., a public switched telephone network (PSTN)), a cable network, a digital subscriber line (DSL) network, a metropolitan area network (MAN), an Internet service provider (ISP) network, and the like. In one example, the other networks 180 may include different types of networks. In another example, the other networks 180 may be the same type of network. In one example, the other networks 180 may represent the Internet in general. In this regard, it should be noted that any one or more of service network 140, other networks 180, or IMS network 150 may comprise a packet data network (PDN) to which an endpoint device may establish a connection via cellular core network 130 in accordance with the present disclosure.

In one example, any one or more of the components of cellular core network 130 may comprise network function virtualization infrastructure (NFVI), e.g., SDN host devices (i.e., physical devices) configured to operate as various virtual network functions (VNFs), such as a virtual MME (vMME), a virtual HHS (vHSS), a virtual serving gateway (vSGW), a virtual packet data network gateway (vPGW), and so forth. For instance, MME 131 may comprise a vMME, SGW 132 may comprise a vSGW, and so forth. Similarly, AMF 135, NSSF 136, SMF 137, UDM 138, and/or UPF 139 may also comprise NFVI configured to operate as VNFs. In addition, when comprised of various NFVI, the cellular core network 130 may be expanded (or contracted) to include more or less components than the state of cellular core network 130 that is illustrated in FIG. 1. It should be noted that intermediate devices and links between MME 131, SGW 132, cell sites 121-124, PGW 134, AMF 135, NSSF 136, SMF 137, UDM 138, and/or UPF 139, and other components of system 100 are also omitted for clarity, such as additional routers, switches, gateways, and the like.

FIG. 1 also illustrates various endpoint devices, e.g., user equipment (UE) 104 and 106. Each of the UEs 104 and 106 may comprise a cellular telephone, a smartphone, a tablet computing device, a laptop computer, a pair of computing glasses, a wireless enabled wristwatch, a wireless transceiver for a fixed wireless broadband (FWB) deployment, or any other cellular-capable mobile telephony and computing devices (broadly, “an endpoint device”). For instance, each of the UEs 104 and 106 may include one or more radio frequency (RF) transceivers for cellular communications and/or for non-cellular wireless communications. In one example, each of the UEs 104 and 106 may be equipped with one or more directional antennas, or antenna arrays (e.g., having a half-power azimuthal beamwidth of 120 degrees or less, 90 degrees or less, 60 degrees or less, etc.), e.g., MIMO antenna(s) to receive and/or to transmit multi-path and/or spatial diversity signals.

In one example, each of the UEs 104 and 106 may comprise all or a portion of a computing system, such as computing system 600 depicted in FIG. 6, and may be configured to perform steps, functions, and/or operations in connection with examples of the present disclosure for configuring the length of radio link control sequence numbers in an intelligent manner. In this regard, it should be noted that as used herein, the terms “configure,” and “reconfigure” may refer to programming or loading a processing system with computer-readable/computer-executable instructions, code, and/or programs, e.g., in a distributed or non-distributed memory, which when executed by a processor, or processors, of the processing system within a same device or within distributed devices, may cause the processing system to perform various functions. Such terms may also encompass providing variables, data values, tables, objects, or other data structures or the like which may cause a processing system executing computer-readable instructions, code, and/or programs to function differently depending upon the values of the variables or other data structures that are provided. As referred to herein a “processing system” may comprise a computing device including one or more processors, or cores (e.g., as illustrated in FIG. 6 and discussed below) or multiple computing devices collectively configured to perform various steps, functions, and/or operations in accordance with the present disclosure.

As illustrated in FIG. 1, UE 104 may access wireless services via the cell site 121 (e.g., NR alone, where cell site 121 comprises a gNB), while UE 106 may access wireless services via any of the cell sites 121-124 located in the access network 120 (e.g., for NR non-dual connectivity, for LTE non-dual connectivity, for NR-NR DC, for LTE-LTE DC, for EN-DC, and/or for NE-DC). For instance, in one example, UE 106 may establish and maintain connections to the cellular core network 130 via one or multiple gNBs (e.g., cell sites 121 and 122 and/or cell sites 121 and 122 in conjunction with BBU pool 126 and/or various other components, such as a CU and/or a DU). In another example, UE 106 may establish and maintain connections to the cellular core network 130 via a gNB (e.g., cell site 122 and/or cell site 122 in conjunction with BBU pool 126) and an eNodeB (e.g., cell site 124), respectively. In addition, either the gNB or the eNodeB may comprise a PCell, and the other may comprise a SCell for carrier aggregation and/or dual connectivity. Similarly, UE 106 may communicate with any of the cell sites 121 and 122 using carrier aggregation (CA) (e.g., in accordance with a CA technique). Furthermore, either or both of NR/5G and or EPC (4G/LTE) core network components may manage the communications between UE 106 and the cellular network 110 via cell site 122 and cell site 124.

In one example, UE 106 may also utilize different antenna arrays for 4G/LTE and 5G/NR, respectively. For instance, 5G antenna arrays may be arranged for beamforming in a frequency band designated for 5G high data rate communications. For instance, the antenna array for 5G may be designed for operation in a frequency band between 1 GHz and 7.125 GHz. In contrast, an antenna array for 4G may be designed for operation in a frequency band less than 5 GHz, e.g., 500 MHz to 3 GHz. In addition, in one example, the 4G antenna array (and/or the RF or baseband processing components associated therewith) may not be configured for and/or be capable of beamforming. Accordingly, in one example, UE 106 may turn off a 4G/LTE radio, and may activate a 5G radio to send a request to activate a 5G session to cell site 122 (e.g., when it is chosen to operate in a non-DC mode or an intra-RAT dual connectivity mode), or may maintain both radios in an active state for multi-radio (MR) dual connectivity (MR-DC).

In accordance with the present disclosure, when a UE 104 or 106 engages with a service, such as a service provided via the service network 140, the AS 195 and/or the cell site 121, 122, 123, or 124 to which the UE 104 or 106 is attached may determine an optimal length of a sequence number for protocol data units associated with the service. In one example, the length of the sequence number is determined based on at least one of: a number of component carriers of a carrier aggregation scheme assigned to the UE 104 or 106, a radio condition (e.g., signal strength as a function of distance from the cell center) of the UE 104 or 106, or a RAN configuration or type of the access network 120 (e.g., O-RAN, C-RAN, D-RAN, V-RAN, cloud RAN, etc.). In a further example, a QCI associated with the service may also factor into the determination of the PDU sequence number length.

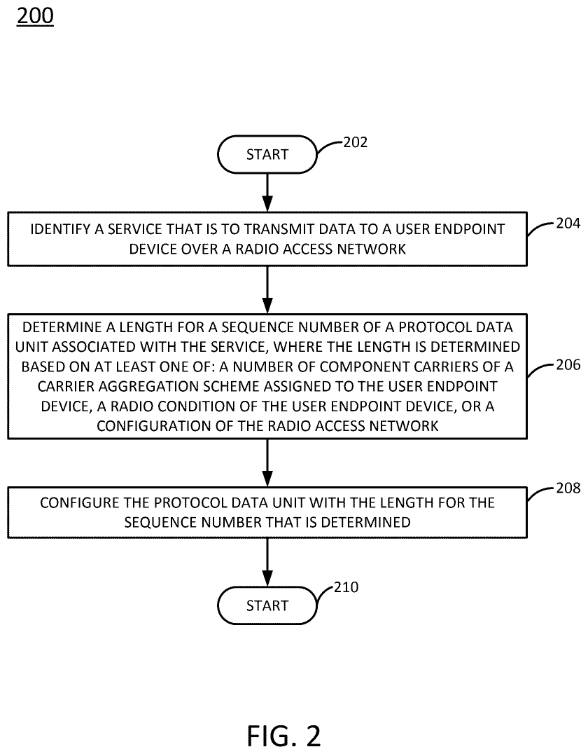

It should be noted that examples of the present disclosure as described herein primarily in connection with steps, functions, and/or operations that are performed by a cellular base station. For instance, FIG. 2 illustrates a flowchart of an example method that may be performed by a serving cell (e.g., a base station and/or any one or more components thereof). However, in other, further, and different examples, various steps, functions, and/or operations as described in connection with FIG. 2, or as described elsewhere herein, may alternatively or additionally be performed by one or more other components. For instance, various steps, functions, and/or operations may alternatively or additionally be performed by a processing system in cellular core network 130, such as application server (AS) 195, AMF 135, SMF 137, MME 131, or the like. To illustrate, in an example in which the foregoing is performed by a base station/cell site, the transmitting of the at least one instruction may be via the base station/cell site to UE 106. However, in an example in which the foregoing may be performed by AS 195, AMF 135, SMF 137, MME 131, or the like, the instruction may be to a cell sites/base station serving UE 106 to activate uplink MU-MIMO communications.

The foregoing description of the system 100 is provided as an illustrative example only. In other words, the example of system 100 is merely illustrative of one network configuration that is suitable for implementing examples of the present disclosure. As such, other logical and/or physical arrangements for the system 100 may be implemented in accordance with the present disclosure. For example, the system 100 may be expanded to include additional networks, such as network operations center (NOC) networks, additional access networks, and so forth. The system 100 may also be expanded to include additional network elements such as border elements, routers, switches, policy servers, security devices, gateways, a content distribution network (CDN) and the like, without altering the scope of the present disclosure. In addition, system 100 may be altered to omit various elements, substitute elements for devices that perform the same or similar functions, combine elements that are illustrated as separate devices, and/or implement network elements as functions that are spread across several devices that operate collectively as the respective network elements.

For instance, in one example, the cellular core network 130 may further include a Diameter routing agent (DRA) which may be engaged in the proper routing of messages between other elements within cellular core network 130, and with other components of the system 100, such as a call session control function (CSCF) (not shown) in IMS network 150. In another example, the NSSF 136 may be integrated within the AMF 135. In addition, cellular core network 130 may also include additional 5G NG core components, such as: a policy control function (PCF), an authentication server function (AUSF), a network repository function (NRF), and other application functions (AFs). In one example, any one or more of cell sites 121-124 may comprise 2G, 3G, 4G and/or LTE radios, e.g., in addition to 5G new radio (NR), or gNB functionality. For instance, cell site 123 is illustrated as being in communication with AMF 135 in addition to MME 131 and SGW 132. Thus, these and other modifications are all contemplated within the scope of the present disclosure.

To further aid in understanding the present disclosure, FIG. 2 illustrates a flowchart of an example method 200 for configuring the length of radio link control sequence numbers in an intelligent manner, in accordance with the present disclosure. In one example, the method 200 may be performed by an application server that is configured to determine radio link control sequence numbers, such as the AS 195 illustrated in FIG. 1, or by a base station such as the cell sites 121, 122, 123, or 124 illustrated in FIG. 1. However, in other examples, the method 200 may be performed by another device, such as the processor 602 of the system 600 illustrated in FIG. 6. For the sake of example, the method 200 is described as being performed by a processing system.

The method 200 begins in step 202. In step 204, the processing system may identify a service that is to transmit data to a user endpoint device over a radio access network.

In one example, the service may be any service that can be provided over a RAN, such as voice calling services, video calling services, media streaming services, extended reality services, gaming services, emergency/first responder services, eMBB services, fixed wireless access services, and the like. In one example, different services may be associated with different QCIs or 5G QoS identifiers (5QIs). For instance, voice calling may be associated with a QCI/5QI of one; video calling may be associated with a QCI/5QI of two; real-time gaming may be associated with a QCI/5QI of three; eMBB may be associated with a QCI/5QI of eight; and emergency services may be associated with a QCI/5QI of six.

In one example, the radio access network may be any type or configuration of radio access network, including a distributed RAN (D-RAN), a centralized RAN (C-RAN), an open RAN (O-RAN), a virtual RAN (V-RAN), a cloud RAN, or the like.

In step 206, the processing system may determine a length for a sequence number of a protocol data unit associated with the service, where the length is determined based on at least one of: a number of component carriers of a carrier aggregation scheme assigned to the user endpoint device, a radio condition of the user endpoint device, or a configuration of the radio access network. In one example, the length of the sequence number is configurable (e.g., anywhere between six and eighteen bits), as discussed above. Since the length of the sequence number will determine the size of the PDU data buffer used by the RLC layer of the RAN, the length of the sequence number should be configured so that there is sufficient room in the PDU data buffer for the PDU data buffer to store all packets needed to reassemble a PDU within a predefined period of time. What is considered “sufficient” room may vary, however, depending upon several factors such as the number of component carriers, the radio conditions of the user endpoint device, and the configuration of the RAN.

For instance, in one example, the processing system may determine a larger sequence number (e.g., a greater number of bits) for carrier aggregation schemes that utilize higher numbers of component carriers. As an example, a sequence number of a first number of bits may be sufficient to support transmissions over a single component carrier; a sequence number of a second number of bits (greater than the first number of bits) may be needed to support transmissions over two component carriers (2CC); a sequence number of a third number of bits (greater than the second number of bits) may be needed to support transmissions over three component carriers (3CC), and so on. Thus, in one example, the size of the sequence number will increase with the number of component carriers.

In one example, the radio conditions of the user endpoint device may comprise a proximity of the user endpoint device to an edge of a cell of the RAN that is serving the user endpoint device. In this case, the processing system may determine a larger sequence number for transmissions for which the user endpoint device is closer to the edge of the cell (or, conversely, further away from the center of the cell). This is because as the user endpoint device moves closer to the edge of the cell, the radio conditions (e.g., radio signal strength) experienced by the user endpoint device may degrade, (e.g., due to low signal-to-noise-plus-interference-ratio, or SINR, levels). As a result, more RLC layer re-transmissions or different types of automatic repeat request (ARQ) may be necessary to ensure receipt of all PDU data packets. For instance, under poor signal conditions, hybrid QRQ (HARQ) may perform better than ARQ (but may result in lower throughput).

In one example, the configuration of the RAN may comprise the specific type of the RAN (e.g., D-RAN, C-RAN, O-RAN, V-RAN, cloud RAN, etc.). In this case, the processing system may determine a longer sequence number for transmissions over RAN configurations that are prone to larger delays between the BBU and RRH (e.g., cloud RANs). In another example, O-RANs, V-RANs, and cloud RANs may be associated with sequence numbers that are four hundred percent longer than the sequence numbers associated with D-RANs or C-RANs, to provide four times more buffer space.

In one example, the length for the sequence number may additionally be determined based on QCI or 5QI. For instance, the processing system may determine a larger sequence number for transmissions for which the QCI or 5QI is higher (indicating that the service is less sensitive to delay). As an example, a QCI of one half may translate into a sequence number length of six bits; a QCI of one (as might be associated with a voice calling service) may translate into a sequence number length of eight bits; a QCI of two (as might be associated with a video calling service) may translate into a sequence number length of ten bits; a QCI of three (as might be associated with a real-time gaming service) may translate into a sequence number length of six bits; a QCI of eight (as might be associated with an eMBB service) may translate into a sequence number length of eighteen bits; and a QCI of six (as might be associated with emergency services) may translate into a sequence number length of twelve bits. Thus, in one example, the size of the sequence number may increase with the QCI or 5QI. It should be noted that in one example, any determination of sequence number length which accounts for QCI (or 5QI) will also account for at least one of: the number of component carriers, the radio conditions of the user endpoint device, or the RAN configuration, as discussed above. Thus, while QCI may be considered in determining the length of the sequence number, QCI is not the only consideration to influence the length of the sequence number.

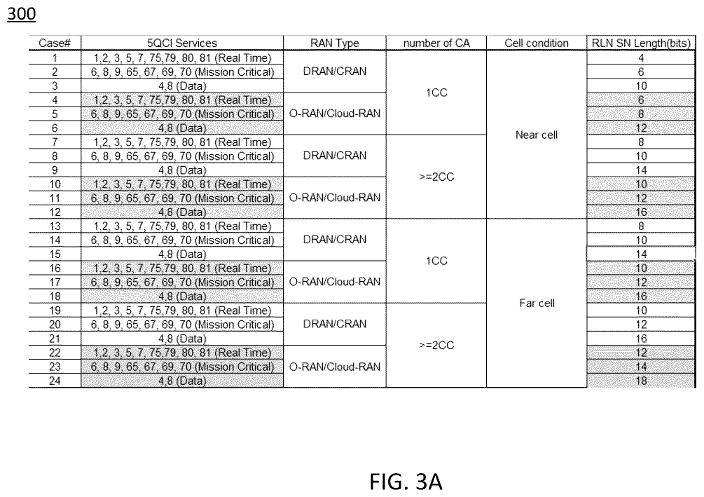

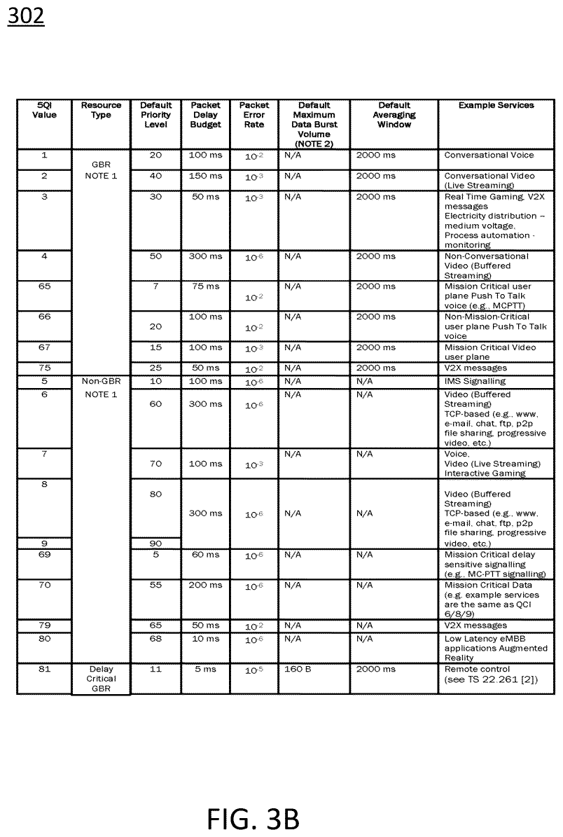

FIG. 3A is a table 300 illustrating one example of a scheme for determining a length for the sequence number in accordance with step 206 of FIG. 2. In particular, FIG. 3A illustrates twenty-four example cases, where each example case is associated with a different combination of values for QCI, RAN type, number of component carriers, and radio (cell) conditions. The final column of the table 300 provides example sequence number lengths (in bits) for each combination of values. It should be noted that FIG. 3A is an example only. For instance, other combinations of values may be possible beyond the combinations illustrated in FIG. 3A. Additionally, other examples may determine different sequence number lengths for the same combinations of values shown in FIG. 3A.

FIG. 3B illustrates a table 302 illustrating example services that may be associated with different combinations of fifth generation quality of service identifiers, resource types, priority levels, delay budgets, error rates, data burst volumes, and averaging windows.

Referring back to FIG. 2, in one example, step 206 may include executing a machine learning model that has been trained to predict an optimal sequence number length based on any combination of the number of component carriers, the radio conditions of the user endpoint device, the RAN configuration, and the QCI. The machine learning model may comprise a neural network, a support vector machine, a decision tree, and ensemble tree, a naïve Bayes classifier, a k-nearest neighbor classifier, or any other type of machine learning model.

In step 208, the processing system may configure the protocol data unit with the length for the sequence number is that is determined. In one example, step 208 may additionally comprise configuring a size of a PDU buffer in the RLC layer to accommodate PDU data packets having sequence number lengths that are equal to the sequence number length that is determined. As discussed above, the length of the sequence number may determine the size of a PDU buffer in the RLC layer that is used to store PDU data packets having the sequence number (e.g., longer sequence numbers will require larger PDU data buffers, while shorter sequence numbers will require smaller PDU data buffers). A PDU data buffer of insufficient size may not be able to store all of the PDU data packets needed to reassemble a PDU within the predefined period of time for reassembly.

The method may end in step 210.

Although not expressly specified above, one or more steps of the method 200 may include a storing, displaying and/or outputting step as required for a particular application. In other words, any data, records, fields, and/or intermediate results discussed in the method can be stored, displayed and/or outputted to another device as required for a particular application. Furthermore, operations, steps, or blocks in FIG. 2 that recite a determining operation or involve a decision do not necessarily require that both branches of the determining operation be practiced. In other words, one of the branches of the determining operation can be deemed as an optional step. However, the use of the term “optional step” is intended to only reflect different variations of a particular illustrative embodiment and is not intended to indicate that steps not labelled as optional steps to be deemed to be essential steps. Furthermore, operations, steps or blocks of the above described method(s) can be combined, separated, and/or performed in a different order from that described above, without departing from the examples of the present disclosure.

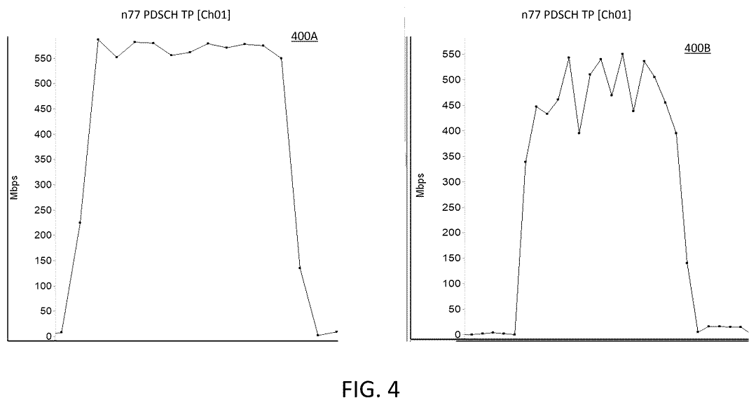

Thus, examples of the present disclosure improve spectrum efficiency and increase throughput in 5G NR networks, while decreasing delay. For instance, FIG. 4 illustrates two charts 400A and 400B comparing the resultant throughput when using a protocol data unit packet sequence number of twelve bits in length (400A) versus using a protocol data unit packet sequence number of eighteen bits in length (400B) for a single component carrier (1CC). Specifically, the single component carrier in this example was a time division duplexing (TDD) n77 carrier.

As the chart 400A illustrates, using the sequence number length of twelve bits resulted in a maximum throughput of approximately 570 megabits per second (Mbps). However, as the chart 400B illustrates, using the sequence number length of eighteen bits resulted in a maximum throughput of approximately 480 Mbps. Thus, by adjusting the length of the PDU sequence number intelligently, throughput can be increased by approximately nineteen percent.

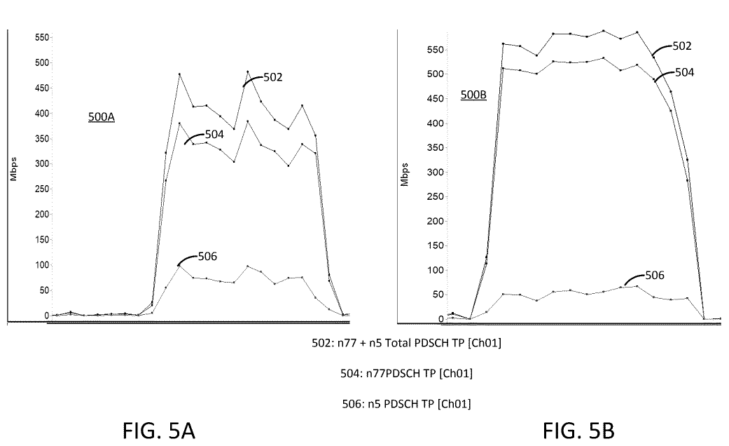

FIG. 5A and FIG. 5B illustrate two additional charts 500A and 500B comparing the resultant throughput when using a protocol data unit packet sequence number of twelve bits in length (500A) versus using a protocol data unit packet sequence number of eighteen bits in length (500B) for carrier aggregation using two component carriers (2CC). Specifically, the carrier in this example was a time division duplexing (TDD) n77 carrier+a frequency division duplexing (FDD) n5 carrier 502. Results for a TDD n77 carrier 504 and an FDD n5 carrier 506 individually are also shown.

As the chart 500A illustrates, using the sequence number length of twelve bits resulted in a maximum throughput of approximately 400 megabits per second (Mbps). However, as the chart 500B illustrates, using the sequence number length of eighteen bits resulted in a maximum throughput of approximately 550 Mbps. Thus, by adjusting the length of the PDU sequence number intelligently, throughput can be increased by approximately thirty percent.

As FIGS. 4, 5A, and 5B illustrated, using the same PDU sequence number length regardless of the number of component carriers can result in large differences in throughput. For instance, based on the example conditions of FIGS. 4, 5A, and 5B, the same PDU sequence number length of twelve bits resulted in a maximum throughput of approximately 570 Mbps for 1CC, but resulted in a maximum throughput of approximately 400 Mbps for 2CC. Similarly, the same PDU sequence number length of eighteen bits resulted in a maximum throughput of approximately 480 Mbps for 1CC, but resulted in a maximum throughput of approximately 550 Mbps for 2CC. Thus, this supports the present disclosure's approach which considers the number of component carriers (among potentially other factors) when determining PDU sequence number length.

FIG. 6 depicts a high-level block diagram of a computing device specifically programmed to perform the functions described herein. For example, any one or more components or devices illustrated in FIG. 1 or described in connection with the method 200 may be implemented as the system 600. For instance, an application server or a radio access network base station (such as might be used to perform the method 200) could be implemented as illustrated in FIG. 6.

As depicted in FIG. 6, the system 600 comprises a hardware processor element 602, a memory 604, a module 605 for configuring the length of radio link control sequence numbers in an intelligent manner, and various input/output (I/O) devices 606.

The hardware processor 602 may comprise, for example, a microprocessor, a central processing unit (CPU), or the like. The memory 604 may comprise, for example, random access memory (RAM), read only memory (ROM), a disk drive, an optical drive, a magnetic drive, and/or a Universal Serial Bus (USB) drive. The module 605 for configuring the length of radio link control sequence numbers in an intelligent manner may include circuitry and/or logic for balancing a combination of factors to determine an optimal sequence number length for a PDU. The input/output devices 606 may include, for example, a camera, a video camera, storage devices (including but not limited to, a tape drive, a floppy drive, a hard disk drive or a compact disk drive), a receiver, a transmitter, a speaker, a display, a speech synthesizer, an output port, and a user input device (such as a keyboard, a keypad, a mouse, and the like), or a sensor.

Although only one processor element is shown, it should be noted that the computer may employ a plurality of processor elements. Furthermore, although only one computer is shown in the Figure, if the method(s) as discussed above is implemented in a distributed or parallel manner for a particular illustrative example, i.e., the steps of the above method(s) or the entire method(s) are implemented across multiple or parallel computers, then the computer of this Figure is intended to represent each of those multiple computers. Furthermore, one or more hardware processors can be utilized in supporting a virtualized or shared computing environment. The virtualized computing environment may support one or more virtual machines representing computers, servers, or other computing devices. In such virtualized virtual machines, hardware components such as hardware processors and computer-readable storage devices may be virtualized or logically represented.

It should be noted that the present disclosure can be implemented in software and/or in a combination of software and hardware, e.g., using application specific integrated circuits (ASIC), a programmable logic array (PLA), including a field-programmable gate array (FPGA), or a state machine deployed on a hardware device, a computer or any other hardware equivalents, e.g., computer readable instructions pertaining to the method(s) discussed above can be used to configure a hardware processor to perform the steps, functions and/or operations of the above disclosed method(s). In one example, instructions and data for the present module or process 605 for configuring the length of radio link control sequence numbers in an intelligent manner (e.g., a software program comprising computer-executable instructions) can be loaded into memory 604 and executed by hardware processor element 602 to implement the steps, functions or operations as discussed above in connection with the example method 200. Furthermore, when a hardware processor executes instructions to perform “operations,” this could include the hardware processor performing the operations directly and/or facilitating, directing, or cooperating with another hardware device or component (e.g., a co-processor and the like) to perform the operations.

The processor executing the computer readable or software instructions relating to the above described method(s) can be perceived as a programmed processor or a specialized processor. As such, the present module 605 for configuring the length of radio link control sequence numbers in an intelligent manner (including associated data structures) of the present disclosure can be stored on a tangible or physical (broadly non-transitory) computer-readable storage device or medium, e.g., volatile memory, non-volatile memory, ROM memory, RAM memory, magnetic or optical drive, device or diskette and the like. More specifically, the computer-readable storage device may comprise any physical devices that provide the ability to store information such as data and/or instructions to be accessed by a processor or a computing device such as a computer or an application server.

While various examples have been described above, it should be understood that they have been presented by way of example only, and not limitation. Thus, the breadth and scope of a preferred example should not be limited by any of the above-described example examples, but should be defined only in accordance with the following claims and their equivalents.

What is claimed is:

1. A method comprising:
identifying, by a processing system including at least one processor, a service that is to transmit data to a user endpoint device over a radio access network;
determining, by the processing system, a length for a radio link control sequence number of a radio link control protocol data unit associated with the service, where the length is determined based on at least one of: a number of component carriers of a carrier aggregation scheme assigned to the user endpoint device, a radio condition of the user endpoint device, or a configuration of the radio access network; and
configuring, by the processing system, the radio link control protocol data unit with the length for the radio link control sequence number that is determined.

2. The method of claim 1, wherein the processing system is part of a base station that serves a cell of the radio access network.

3. The method of claim 1, wherein the radio access network is at least one of: a distributed radio access network, a centralized radio access network, an open radio access network, a virtualized radio access network, or a cloud radio access network.

4. The method of claim 1, wherein the length for the radio link control sequence number increases with the number of component carriers of the carrier aggregation scheme.

5. The method of claim 1, wherein the radio condition of the user endpoint device comprises a proximity of the user endpoint device to an edge of a cell of the radio access network that is serving the user endpoint device.

6. The method of claim 5, wherein the length for the radio link control sequence number increases with a distance of the user endpoint device from a center of the cell.

7. The method of claim 1, wherein the configuration of the radio access network comprises a type of the radio access network.

8. The method of claim 1, wherein the length for the radio link control sequence number is larger for a cloud radio access network than for a distributed radio access network, a centralized radio access network, an open radio access network, or a virtualized radio access network.

9. The method of claim 1, wherein the length for the radio link control sequence number is further determined based on a quality of service class identifier for the service.

10. The method of claim 1, wherein the determining is performed using a machine learning model that is trained to predict the length for the radio link control sequence number based on the at least one of: the number of component carriers of the carrier aggregation scheme assigned to the user endpoint device, the radio condition of the user endpoint device, or the configuration of the radio access network.

11. The method of claim 1, wherein the configuring further comprises configuring a size of a protocol data unit buffer in a radio link control layer of the radio access network, based on the length for the radio link control sequence number that is determined, to accommodate packets containing the radio link control protocol data unit.

12. The method of claim 1, wherein when the length of the radio link control sequence number is determined to be below a threshold length, the processing system enables multiple user multiple input, multiple output communications for the service.

13. The method of claim 12, wherein the length of the radio link control sequence number is determined to be below the threshold length when the length of the radio link control sequence number exceeds a radio link control buffer threshold.

14. A non-transitory computer-readable medium storing instructions which, when executed by a processing system including at least one processor, cause the processing system to perform operations, the operations comprising:
identifying a service that is to transmit data to a user endpoint device over a radio access network;
determining a length for a radio link control sequence number of a radio link control protocol data unit associated with the service, where the length is determined based on at least one of: a number of component carriers of a carrier aggregation scheme assigned to the user endpoint device, a radio condition of the user endpoint device, or a configuration of the radio access network; and
configuring the radio link control protocol data unit with the length for the radio link control sequence number that is determined.

15. The non-transitory computer-readable medium of claim 14, wherein the length for the radio link control sequence number increases with the number of component carriers of the carrier aggregation scheme.

16. The non-transitory computer-readable medium of claim 14, wherein the radio condition of the user endpoint device comprises a proximity of the user endpoint device to an edge of a cell of the radio access network that is serving the user endpoint device.

17. The non-transitory computer-readable medium of claim 16, wherein the length for the radio link control sequence number increases with a distance of the user endpoint device from a center of the cell.

18. The non-transitory computer-readable medium of claim 14, wherein the configuration of the radio access network comprises a type of the radio access network, and wherein the length for the radio link control sequence number is larger for a cloud radio access network than for a distributed radio access network, a centralized radio access network, an open radio access network, or a virtualized radio access network.

19. The non-transitory computer-readable medium of claim 13, wherein the length for the radio link control sequence number is further determined based on a quality of service class identifier for the service.

20. A device comprising:
a processing system including at least one processor; and
a computer-readable medium storing instructions which, when executed by the processing system, cause the processing system to perform operations, the operations comprising:
identifying a service that is to transmit data to a user endpoint device over a radio access network;
determining a length for a radio link control sequence number of a radio link control protocol data unit associated with the service, where the length is determined based on at least one of: a number of component carriers of a carrier aggregation scheme assigned to the user endpoint device, a radio condition of the user endpoint device, or a configuration of the radio access network; and
configuring the radio link control protocol data unit with the length for the radio link control sequence number that is determined.
